(19) United States
(12) Patent Application Publication
(10) Pub. No.: US 2011/0262745 A1
(43) Pub. Date: Oct. 27, 2011

(54) COATED RECYCLABLE PAPER OR PAPERBOARD AND METHODS FOR THEIR PRODUCTION

(76) Inventor: Sirkku Johanna Ronka, Espoo (FI)

(21) Appl. No.: 13/128,014

(22) PCT Filed: Nov. 5, 2009
(86) PCT No.: PCT/IB2009/007415

§ 371 Date: May 6, 2011

Related U.S. Application Data
(60) Provisional application No. 61/112,526, filed on Nov. 7, 2008.

(51) Int. Cl. B32B 27/10; B32B 29/06; B05D 3/12; B05D 7/00; B05D 3/00

(52) U.S. Cl. 428/349; 427/374.1; 427/9; 427/209

(57) ABSTRACT

A method is provided for producing a wide range of high quality coated recyclable paper or paperboard for use in a variety of applications. In accordance with the process, paper or paperboard is coated with a polymer emulsion in one or more coating stations which are off-line from a paper or paperboard machine. The process provides coated paper or paperboard products with enhanced barrier properties.

This invention relates to coated recyclable paper or paperboard products and methods for their production. More particularly, paper or paperboard is coated with a polymer emulsion in one or more coating stations which are off-line from the paper or paperboard machine. The coating compositions and process of the invention are effective for providing coated paper or paperboard products with enhanced barrier properties.

### BACKGROUND

Coated paper and paperboard products having barrier properties are of great importance for packaging food or other products that are sensitive to environmental influences. Desirable barrier properties include grease resistance and low water penetration, as well as a smooth and uniform surface finish. In many applications the coating is also heat sealable. Known coating methods include dispersion coating, in which coating compositions of water soluble dispersion polymers, pigments and other agents are applied to the substrate using coating techniques such as blade coating, bar (rod) coating, reverse roll (film) coating, or air knife coating. Premixed coatings available from a number of coating suppliers are applied to the paperboard web at the paperboard machine. The use of premixed bulk coating compositions limits the degree to which coating compositions can be custom designed to achieve the barrier and other properties desired for a particular packaging or other product. Typically paper and paperboard are produced with the machines, where coating is performed on coating stations that are directly integrated with the paper or paperboard machines. Using in-line coating, the paperboard web is at an elevated temperature when the coating is applied, which results in greater penetration of the coating into the paperboard and a lower effective coating thickness and makes it difficult to consistently achieve the desired coating properties at the minimal cost. Because in-line coating systems are tied to the paper or paperboard production process, they are relatively inflexible are not easily adapted for smaller production runs of, for example, specialty coated paperboard products to be manufactured in relatively small production runs.

Conventional production methods utilizing in-line coating systems have additional drawbacks of difficulty in designing and testing new coating formulations during paper or paperboard production runs, and difficulty and expense of modifying existing equipment to provide for specialty products such as products that include multiple coating layers of the same or different coating compositions. An improved system and processes is needed that can easily and economically be adapted to provide a wide variety of coated paper and paperboard products having a range of desired barrier properties. Such processes should be capable of economically producing both large and small quantities of high quality dispersion coated paper and paperboard products that are optimized to meet the particular needs of the finished product. Further, coating compositions and processes are needed that provide desired barrier properties while at the same time improve the capacity to recycle waste paper and paperboard products in order to reduce both production costs and the environmental impact of the manufacturing process and finished products.

### SUMMARY

A highly adaptable production system and method is provided for producing a wide range of high quality coated recyclable paper or paperboard for use in a variety of applications. To enable further flexibility, coating compositions are applied to paper or paperboard at one or more coating stations that are offline from the paperboard manufacturing unit yet preferably located in the same manufacturing facility. Thus, the paper or paperboard web is cool at the time of coating application, which affords better control of the coating process and lowers the amount of coating needed to achieve desired barrier properties. Because the coating is decoupled from the paperboard manufacturing, the coating speed and other conditions can be controlled as necessary independent of the operating parameters of the paperboard manufacturing machine. The system is easily adapted for producing multi-layer products by providing multiple off-line coating stations in series and intermittent drying stations to dry the coating before the next coating is applied. The system also includes a final drying station after the last coating station and then a cooling station to cool the coated paper or paperboard to prevent the heat sealable surface from sticking when the product is rolled onto reels for storage.

An improved process for producing coated paper or paperboard products is also described. A mixing system is provided for combining water based polymer emulsions, pigment and optional additives in ratios selected to achieve desired solids content, solids dispersion, viscosity and other properties required to achieve desired coating barrier and other properties. Thus, a wide range of specific coating compositions can be prepared on site, which affords greater flexibility in the properties and performance of the finished product as compared to systems that are limited to using those coating compositions which are generally available from industrial coating suppliers.

Coating compositions are provided that include, for example, about 70 to about 90 weight %, based on the dry weight of the coating, of a water based polymer emulsion, and about 10 to about 30 weight %, based on the dry weight of the coating, of pigment. Additives such as defoamers, dispersing agents and thickeners may also be included. Such coatings may have a viscosity of about 400 to about 1000 mPas and a solids content of about 40 to about 60 weight percent, based on the weight of the coating. In another aspect of the invention, one or more dispersion polymers are included in a first coating composition for providing good grease resistance, a second coating composition is prepared to provide good water resistance properties, and a third coating composition may be provided as a precoating to provide a moisture vapor barrier and some grease resistance. These coatings may then be applied in various combinations to provide a multi-layer coated paper or paperboard having a desired range of barrier properties.

The aqueous coating is applied to the paper or paperboard having a temperature of 40° C. or less on at least one side. The aqueous coating is dried to provide a coated paper or paperboard. The coated paper or paperboard is contacted with a cylinder to provide a coated paper or paperboard having a temperature of 40° C. or less. The cooled coated paper may be further processed with calandering.

The methods described are effective for providing a coated paper or paperboard product. The coated paper or paperboard product includes a baseboard layer coated on at least one side with a first coating layer formed from a first acrylic polymer emulsion. The coated paper or paperboard product also includes a second coating layer which contacts the first coating layer. The second coating layer includes a second coating layer formed from a second acrylic emulsion. The coated paper or paperboard product has a water resistance of below 10 g/m² measured with Cobb water absorption test (time 30 minutes per ASTM D 3285 which is incorporated herein by reference), moisture vapor resistance (MVTR-value per ASTM E 96, which is incorporated herein by reference) of below 120 g/m² in 24 hours (temperature 25° C., relative humidity 75%) and provides a grease penetration of 0 after 15 minutes at a temperature of 200° C. (per a baking test described herein in Example 4). Furthermore, the coating retains its barrier properties of water resistance and moisture vapor resistance at temperature of 220° C. The coating or any substances in the coatings does not migrate to food in contact with the coating (as determined per European FDA test method BfR XXXVI and BfR XXXVI/2, which are incorporated herein by reference). At the same time coating is heatsealable with pressure of 80-100 psi and temperature of 160-200° C. and time of 1-1.5 seconds.

In another aspect, the coated paper or paperboard product includes a baseboard layer coated on at least one side with a first coating layer formed from a styrenebutadiene polymer emulsion. The coated paper or paperboard product also includes a second coating layer which contacts the first coating layer. The second coating layer includes a second coating layer formed from an acrylic emulsion. The coated paper or paperboard product has a water resistance of below 7 g/m² measured with Cobb water absorption test (time 30 minutes), moisture vapor resistance (MVTR-value) of below 30 g/m² in 24 hours (temperature 25° C., relative humidity 75%) and provides a grease penetration of 0 after 15 minutes at a temperature of 200° C. Furthermore, the coating retains its barrier properties of water resistance and moisture vapor resistance at temperature of 220° C. The coating or any substances in the coatings does not migrate to food in contact with the coating. At the same time coating is heatsealable with pressure of 80-100 psi and temperature of 160-200° C. and time of 1-1.5 seconds.

In another aspect, paper or paperboard may include multiple coating layers. The second coating layer can be applied after the first layer is dried. The cooling and calandering is done after last coating layer. There is no upper limit, but in practice three layers is maximum for bigger volumes. First layer can be added on the board machine by surface sizing. Then two layers on the board machine. These three layers go to the reverse side of the board to give barrier properties. The top side can be coated in the same run with the pigment coating (two stations on the top side). Coating layers may all include the same polymer emulsion or each coating layer may be formed from a different polymer emulsion. Different coating layers may be utilized to provide various coating properties to an end product.

In another aspect, paper or paperboard may be coated on both sides. Each side may include a single or multiple coating layers. For example, products made in accordance with the invention may include heat sealable barrier coatings on one side and one or more pigment coatings on the opposite side. In one preferred approach, multiple off-line coating stations are provided on each side of the paperboard such that one or more identical or different coating compositions may applied in layers on each side during a single production run.

In yet another aspect of the invention, the coating compositions are formulated such that trim waste and other waste generated during the coating process may be recycled to the paperboard production process without the need to first separate the applied coating or coatings from the substrate. It has been found that the compositions of the invention permit such material to be reused in the paperboard pulping process without having an adverse effect on the resulting paperboard. Preferably, the off-line coating stations are co-located at the paperboard manufacturing facility to minimize the cost of transporting the waste paper to the paper manufacturing system.

### BRIEF DESCRIPTION OF THE DRAWINGS

FIG. 1 is a flow diagram generally illustrating a process for manufacturing coated recyclable paper or paperboard.

FIG. 2 illustrates off-line coating machines.

FIG. 3 shows a coated paperboard product.

### DETAILED DESCRIPTION

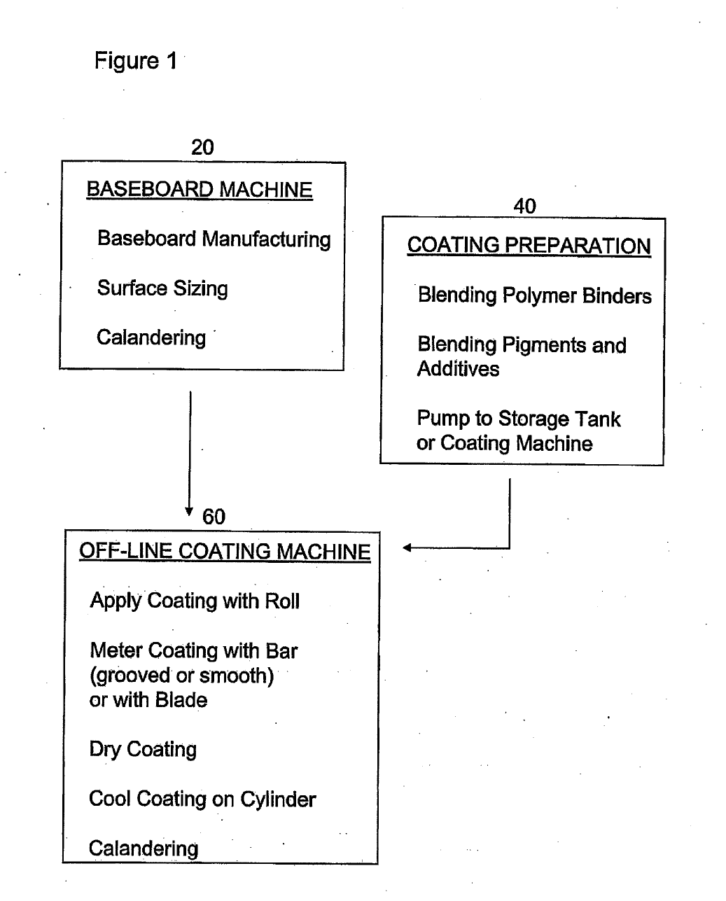

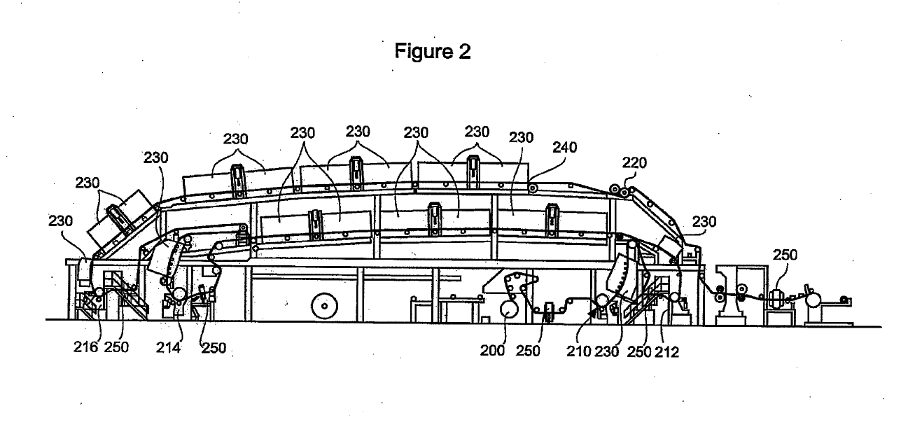

A flowchart generally describing a process for manufacturing coated recyclable paper or paperboard is illustrated in FIG. 1. FIG. 2 illustrates in more detail the overall system and process of a preferred embodiment of the invention that incorporates coating stations into the process. As generally described in FIG. 1, paper or paperboard is produced by a baseboard machine 20 in a conventional manner. Uncoated paper or paperboard and coating compositions are supplied to one or more off-line coating machines 60. The coating process includes applying the polymer emulsion coating to at least one surface of the paper or paperboard. Water present in the polymer emulsion is removed in one or more drying stations, followed by subsequent cooling of the finished product.

### Paper and Paperboard

Baseboard machines know in the industry may be utilized to produce paper or paperboard. For example, one type of baseboard machine that may be used is manufactured by Ahlstrom. Baseboard machine may be operated using parameters commonly known in this industry. The baseboard machine 20 provides surface sizing and calandering of the paper or paperboard to provide a substrate having desired thickness, grain density and smoothness. Unlike conventional systems for producing coated paper and paperboard products, the paper or paperboard manufacturing system of the present invention is preferably not utilized for coating operations.

A wide range of uncoated paper or paperboard produced in the baseboard machine may be used for subsequent coating. Any type of fiber based material may be coated, such as for example bleached or unbleached, hardwood or softwood, virgin or recycled, uncoated forms of paper or paperboard. The basis weights of the paper or paperboard produced are preferably in the range of 80 to 300 lbs per 3,000 sq. ft. and have a thicknesses range from 0.008 to 0.025 inches.

Paper or paperboard is prepared to provide constant surface properties which are effective for minimizing water penetration. In this aspect, paper or paperboard is sized to provide a Cobb Value of 40 g/m² (60 seconds) or less. Preferably there are no fluorochemicals used in the baseboard to improve grease resistance.

### Coating Compositions

A coating composition is provided for coating paper or paperboard. The coating composition is an aqueous dispersion of synthetic polymers and pigment. The synthetic polymers are generally used as binders to fix the pigment to the paper or paperboard.

Coating composition may include from about 70 to about 90 weight %, based on the dry weight of the coating, of synthetic polymer emulsion, and from about 10 to about 30 weight %, based on the dry weight of the coating, of pigment.

Synthetic polymers that may be utilized to form water based emulsions include acrylic polymers, acrylic copolymers, copolymers of styrene and butadiene, vinyl acetate polymers, polyvinyl alcohol, poly-ethylene vinyl acetate, polyethylene vinyl chloride, polyvinylidiene chloride, and mixtures thereof. Examples of suitable acrylic and/or methacrylic acid esters include ethyl acrylate, methylmethacrylate, butylacrylate, 2-theylhexyl acrylate, methylacrylate, ethylmethacrylate, and the like, and mixtures thereof.

The pigment may be selected from any pigment useful for substrate coating compositions. Exemplary suitable pigments are aqueous dispersions of coating grade clays, such as kaolin clays, titanium dioxide, calcium carbonate, barium sulfate, talc, zinc sulfate, aluminum sulfate, calcium oxide reaction products, lithopone, zinc sulfide, other coating pigments, other similar materials, and mixtures thereof. In one aspect, pigments that may be utilized include talc and clays.

In one aspect, talc is utilized as the pigment. Talc may be added as a dry powder or granules containing 5-15% of water instead of a slurry. Addition of talc as a dry powder provides a higher solids content and higher viscosity while minimizing the amount of any thickeners needed.

Coating composition will have a viscosity of about 400 to about 1000 mPas and a solids content of about 40 to about 60 weight percent, based on the weight of the coating.

The coating composition may include additives. Additives may include thickening agents, defoaming or antifoaming agents, dispersing aids, additional pigments, crosslinking agents, slip additives, release agents and antiblocking agents. Preferably there are no fluorochemicals used in the baseboard to improve grease resistance.

Coating compositions are prepared in coating preparation tanks 40 by blending polymers, water, pigments and optional additives to form a polymer emulsion. Mixing is typically conducted for about 20 to about 30 minutes, and may be repeated as necessary to avoid settling of solid components. Viscosity may be adjusted with addition or water or thickening aids. The polymer emulsion may be stored in storage tanks or transported directly to an off-line coating machine 60. The coatings are preferably mixed just before use so as to have optimal properties and avoid the adverse effects of pigment coagulation and sedimentation that may occur over time. If stored, the coating compositions are preferably agitated by a mixer and/or recirculation to minimize sedimentation.

### Coating Application

As shown in FIG. 2, the preferred embodiment of the system of the invention includes at least one, and preferably multiple, off-line coating stations 210, 212, 214, and 216 co-located at the same facility as the paperboard, manufacturing system. As used herein “off-line” refers to a coating machine that can be operated independently of the baseboard machine and is not required to be in the same production line. The off-line coating machine may be located in the same factory as the machine that provides the paper or paperboard substrate to be coated. The use of an off-line coating machine is effective for providing more optimal coatings. For example, in online coating, the paper or paperboard substrate is hot when coating is applied. Coatings penetrate a higher temperature substrate more than a cool substrate. The increase coating penetration results in a lower coating thickness and a poorer quality and higher costing product. The use of the off-line coating machine, allows the paper or paperboard to reach a temperature of 40° C. or less prior to coating. The baseboard may be held for a sufficient time to cool it or a cooling station 220 may be added to cool the baseboard more quickly in advance of another coating station. Thus, it has been found that higher quality coatings can be applied at a smaller effective coating layer thickness on the cooled substrate as compared to in-line coating directly onto the hot web of the baseboard manufacturing machine.

Paper or paperboard is preferably cooled to a temperature of less than about 40° C. prior to coating, and most preferably about 30° C. Cooling may be accomplished for example by blowing cool air over the web or keeping the paper or paperboard reel in room temperature long enough for it to cool down. Paper or paperboard may be supplied to a coating station from a paper or paperboard roll 200 as shown in FIG. 2. Coating compositions may be applied to at least one surface of the paper or paperboard by any known means, such as by air knife, blade coating, metering roll coating, gravure coating, rod coating, curtain coating and spraying. In an important aspect, coating layers are metered onto the paper or paperboard with a rod/bar which is effective for providing a more even coating thickness. Coating amount of each layer applied with a rod/bar will be from about 5 g/m² to about 10 g/m² with a variation in thickness of 1 g/m² or less over a surface of the coated substrate. Grooved rods are especially effective for applying coating compositions to paper of paperboard. The size of the grooves is selected to give 5-10 g/m² coating weight for each layer with specific coating mixture in question. The solid content, viscosity and other reological properties of the coating influence on groove size selection. Typically rods are surface treated with chrome and have diameter of 10-15 mm

As shown in FIG. 2, a topside precoating may be applied in a coating station 200. Drying stations 230 are preferably located in between each successive coating station to reduce the water content of the coating before the next coating is applied. Drying of the coatings is accomplished with hot air directed to the coated paper or paperboard web. Heated air is provided using known techniques, such as for example, propane heat. Air is continuously recirculated with removal of moisture. In this aspect, heated air having a temperature of about 100 to about 150° C. is provided to the paper or paperboard web such that the temperature of the web does not exceed about 110° C. In one aspect of the invention, the temperature of the web after the first coating station is from about 80 to about 90° C. and after a second set of coating and drying stations is from about 105 to about 110° C. Web temperatures may be determined at multiple locations, such as for example at a web temperature measuring point 240.

The water based emulsion coatings have dry coating weights in the range of 5 to 15 g/m², typically 7 to 8 g/m² in one layer. Drying temperatures and line speeds are dictated by the drying characteristics of specific coating formulations, for example the % solids content, substrate basis weight and absorptivity, and equipment characteristics. The amount of coating applied may be measured at coating measuring points 250. Drying conditions should be controlled to prevent blistering of the coating and roll blocking or picking of the coating during rewinding of the coated substrate or delaminating of the paperboard.

In another aspect, each side of the paper or paperboard may include multiple coating layers. These layers may be applied by using multiple off-line coating machines 210, 212, 214, and 216 as shown in FIG. 2. Each off-line coating machine may be used to coat the same or a different polymer emulsion than the first coating machine. Alternatively, multiple coatings may be applied using the same coating machine. The type of polymer emulsion used for additional coating layers may be the same or different than the previous coating layer.

Generally, the first layer is optimized to provide optimal grease resistance and moisture barrier properties and the second layer serves to provide additional water barrier properties and to provide a heat sealable surface. However, other approaches are also possible within the scope of the invention herein.

The system preferably includes multiple coating stations effective for independently coating both sides of the substrate with one or multiple layers in same production run. The desired coating composition is supplied to the particular coating station at which it is to be applied. Thus, for example, the system may be provided with two coating stations for applying two successive pigment layers suitable for surface printing on a first side of the substrate, and two additional coating stations provided for coating the opposite second side of the substrate with two barrier layers for providing adequate grease and moisture resistance and heat sealable properties. Due to the use of off-line coating stations, such a system can be readily adapted for providing greater or fewer layers on either or both sides of the substrate by simply adjusting the number of coating stations utilized, without the need to reconfigure the paper or paperboard manufacturing machine. Coating compositions themselves can also easily be altered at the mix stations to vary the properties of each layer. Thus, a wide array of specialty designed products can be manufactured because changing from one product to another is a relatively simple operation and does not require changing the configuration or operations of the paperboard manufacturing machine.

The use of off-line coating stations has the further advantage of enabling coating of baseboards produced by remote facilities.

In another aspect, coating thicknesses are measured using IR-spectroscopy. The on-line IR-spectroscopy measurement allows for continuous monitoring of coating thicknesses so that operational parameters can be adjusted as necessary to consistently achieve the desires coating thickness. Preferably, the amount of each applied coating layer can be measured in order to achieve similar barrier and other properties in every production run and avoiding the cost of using excess coating. Measuring may be conducted at measuring points 250 shown in FIG. 2.

After the one or more coating stations, the coated paper or paperboard is dried in another drying station and then cooled before reeling on a cylinder. Cooling of the coated and dried paper or paperboard is done using cool air and cooling cylinders, where water is circulated inside a cylinder rolling against the web (shown as 220 in FIG. 2). The cool water is directed in from the other end of the cylinder and out from the another. There are two cooling cylinders, one on each side of the paper or paperboard web. Cooling is effective for providing a coated paper or paperboard with a temperature of 40° C. or less. Proper drying is necessary to achieve good film formation and good barrier properties while avoiding sticking of the heat sealable coatings in the reels, also known as “blocking.” The cooling conditions are selected to stop the drying at the correct stage so as to avoid complete drying so that the coating is heat sealable, while providing sufficient drying to prevent blocking

After cooling, the coated paper or paperboard may be calandered.

Further advantages of the system and process of the invention reside in the fact that all coated paperboard waste from the process may be recycled directly to the baseboard manufacturing process without separating the coating prior to recycling. In this aspect 100% of the coated paperboard waste is recycled. In this regard, it is preferably that the coating compositions utilized contain no detectable levels of waxes. Although waxes are typically used in many coating to improve water resistance and to provide a vapor barrier, waxes have a negative effect on recycling as they cause stickies in the pulp and gluing of coatings to the paper or paperboard substrate. The compositions described herein are suitable for providing excellent barrier properties without the need for wax components. When coating is performed in the same mill where the paper or paperboard is produced, transportation costs for transporting coated paperboard waste is reduced.

### Coated Paper or Paperboard Products

Coated paper or paperboard products produced in accordance with the process described herein compostable and recyclable without separating the coating. The coated paper or paperboard products may be used to provide moisture resistance and grease resistance. The coated paper or paperboard products are heatsealable and can be microwaved. Coating paper and paperboard products may be used for a variety of food packages such as for example bakery packaging, salad trays, frozen food containers, sandwich packaging, candies and gum.

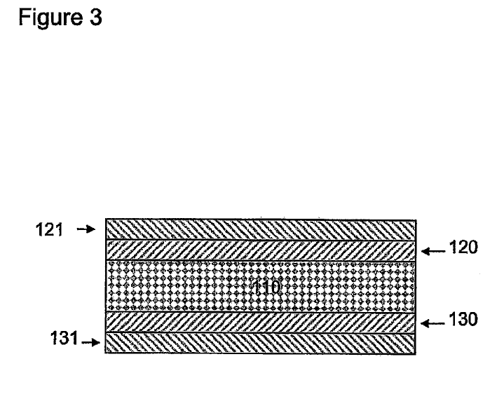

FIG. 3 generally illustrates a coated paperboard. As illustrated in FIG. 3, the paper or paperboard product may include a baseboard middle layer 110. The baseboard middle layer 110 generally includes mechanical pulp and mill pulp and may include chemical pulp regions either side of the middle layer resulting from a bleaching process. The mechanical pulp in the middle layer provides bulk, while the chemical pulp layers provide flexibility as well as higher whiteness. The baseboard can also be produced totally from chemical pulp, or can contain recycled pulp. Also paper can be used as base material to be coated.

The baseboard middle layer 110 may be coated on one side with a pigment pre-coating layer 120 and a pigment top-coating layer 121. These layers offer good surface printability. By providing two pigment layers, the coating can be provided more evenly with fewer variations and pin holes. First barrier layer 130 and second barrier layer 131 may be applied on the opposite side to provide the desired barrier properties in the finished material, such as grease resistance, water barrier and heat resistance.

The examples that follow are intended to illustrate the invention and not to limit it. All percentages used herein are by weight unless otherwise indicated. All patents, patent applications, and literature references cited herein are hereby incorporated by reference in their entirety.

### EXAMPLE

### Example 1

### Preparation of Coatings

Coatings were prepared with the types and amounts of components described below.

### Coating A: (46.3% Solids)

| Component | Amount (kg) |
|---|---|
| Acrylic Emulsion | 867 |
| Talc (dry powder) | 124 |
| Synthetic Defoamer | 5.0 |
| Dispersing Aid | 1.3 |
| Synthetic Thickener | 3.3 |

### Coating B: (56% Solids)

| Component | Amount |
|---|---|
| Acrylic Emulsion | 779 |
| Talc (dry powder) | 185 |
| Synthetic Defoamer | 4.4 |
| Dispersing Aid | 1.9 |

### Coating C: (60% Solids)

| Component | Amount |
|---|---|
| Styrenebutadiene | 1000 |
| dispersion | |

### Example 2

### Preparation of Grease and Moisture Resistant Coated Paperboard

Paperboard, Strom-baseboard 231 g/m², produced at Stromdal's board machine is supplied to an off-line coating machine. The paperboard is coated with Coating A described in Example 1 at coating weight of 8 g/m². The coated paperboard is dried with hot air at a temperature of 260° C. for about 0.4 seconds to provide a web temperature of 70-90° C. After Coating A has been applied, Coating B as described in Example 1 is applied at the next coating station using the same procedure as used for applying Coating A. Coating B is applied a rate of 7 g/m². The coated paperboard is dried with hot air at a temperature of 500° C. for about 0.4 seconds, then followed by drying with hot air at temperature of 160° C. for about 4 seconds. After this the web temperature reaches temperature of 100-108° C. The coated and dried paperboard substrate is cooled by contacting the substrate with a roller having a temperature of 30-40° C. and cool air so that the web temperature reaches 30-40° C. before reeling the paperboard web in a Pope reeler. The topside is coated with the printable pigment coating. The cooled substrate is calandered by passing the substrate through rollers having nip pressure 40 kN/m and temperature of 160° C. Coating layer A provides the paperboard with a grease penetration of 0 after 15 minutes at an oven temperature of 200° C. Coating layer B provides a moisture barrier. Water resistance is below 10 g/m² measured with Cobb water absorption test (time 30 minutes). The resulting coated paperboard has surface properties that make it effective for further processing, such as for example in heatsealable, non-blocking uses. The coating withstands oven temperature of 220° C. without loosing its barrier properties. Further, any substances in the coating do not migrate to the food in contact with the coating. At the same time, the coating is heatsealable with pressure of 80-100 psi and temperature of 160-200° C. and time 1-1.5 seconds. As used herein, “heatsealable” refers to material that sealus under pressure and elevated temperature without adhesives and which results in fiber tear when two heatsealable surfaces are separated. The coating can also be glued with waterbased glues without perforating the surface or any need for corona treatment as needed with traditionally used extruded polyolefines like PE-coatings.

### Example 3

### Preparation of Paper Board with Moisture Barrier and Grease Resistance

Paperboard is supplied to a coating machine. The paperboard is coated with Coating C described in Example 1 at rate of 8 gsm. The coated paperboard is dried at a temperature of 200° C. for about 0.4 seconds. Coating B as described in Example 1 is then applied at the next coating station using the same procedure as used for applying Coating C. Coating B is applied at a of 7 g/m². The coated paperboard is dried with hot air at a temperature of 500° C. for about 0.4 seconds, then followed by drying with hot air at temperature of 160° C. for about 4 seconds. After this the web temperature reaches temperature of 100-108° C. The coated and dried paperboard substrate is cooled by contacting the substrate with a roller having a temperature of 30-40° C. and cool air so that the web temperature reaches 30-40° C. before reeling the paperboard web in a Pope reeler. The topside is coated with the printable pigment coating. The cooled substrate is calandered by passing the substrate through rollers having nip pressure 40 kN/m and temperature of 160° C. Coating layer B provides the paperboard with a grease penetration of 0 after 15 minutes at an oven temperature of 200° C. Coating layer C provides a moisture barrier. Water resistance is below 10 g/m² measured with Cobb water absorption test (time 30 minutes). The resulting coated paperboard has surface properties that make it effective for further processing, such as for example in heatsealable, non-blocking uses. The coating withstands oven temperature of 220° C. without loosing its barrier properties. Further, any substances in the coating do not migrate to the food in contact with the coating. At the same time, the coating is heatsealable with pressure of 80-100 psi and temperature of 160-200° C. and time 1-1.5 seconds. As used herein, “heatsealable” refers to material that sealus under pressure and elevated temperature without adhesives and which results in fiber tear when two heatsealable surfaces are separated. The coating can also be glued with waterbased glues without perforating the surface or any need for corona treatment as needed with traditionally used extruded polyolefines like PE-coatings.

Tow layers of coating color, 11 g/m² each, are applied on the opposite side of the paperboard. Pigments are mainly calcium carbonate, but also clay is used on the top coat layer. The pigment coatings are applied with the same coating stations, but blades are used instead of rods or grooved rods to meter the needed coating weight and have even coating surface.

### Example 4

### Baking Test

Baking test is done for a 10×10 cm sample of coated paperboard. Butter pastry is placed on coated side and baked at 200° C. for 15 minutes. After cooling (5 minutes) the grease penetration through the coating is checked from the uncoated side of the board. Scale is 0-5, where 0 means no grease penetration.

### Evaluation Scale

| Value | Penetration of the grease in uncoated side |
|---|---|
| 0: | No grease penetration |
| 1: | couple of grease spots |
| 2: | several spots |
| 3: | <50% of the area (or line) |
| 4: | >50% of the area (or line) |
| 5: | Whole area |

While the invention has been particularly described with specific reference to particular process and product embodiments, it will be appreciated that various alterations, modifications, and adaptations may be based on the present disclosure, and are intended to be within the spirit and scope of the invention as defined by the following claims.

What is claimed is:

1. A method of producing a coated recyclable paper or paperboard comprising:
a) supplying an aqueous coating to at least one coating machine, the aqueous coating including about 70 to about 90 weight %, based on the dry weight of the coating, of a polymer emulsion, and about 10 to about 30 weight %, based on the dry weight of the coating, of pigment;
b) applying the aqueous coating to paper or paperboard to provide a coating layer on the paper or paperboard;
c) drying the aqueous coating layer to provide a coated paper or paperboard; and
d) cooling the coated paper or paperboard,
wherein coating, drying and cooling are conducted at temperatures effective for providing a coated paperboard product with a water resistance of less than about 10 g/m² and a moisture vapor transfer rate of less than 120 g/m²,
wherein the coated paper or paperboard product is heat sealable.

2. The method of claim 1, wherein aqueous coating is supplied to an off-line coating machine.

3. The method of claim 2, wherein the off-line coating machine is in a same location as a machine supplying paper or paperboard.

4. The method of claim 1, wherein aqueous coating is applied to a paper or paperboard having a temperature of 40° C. or less.

5. The method of claim 1, wherein the coated paper or paperboard is cooled with air cooling or by containing the coated paper or paperboard with a cooling cylinder.

6. The method of claim 5, wherein the cooling cylinder has a temperature of 40° C. or less.

7. The method of claim 1, wherein the aqueous coating has a viscosity of about 400 to about 1000 mPas and a solids content of about 40 to about 60 weight percent, based on the weight of the coating.

8. The method of claim 1, wherein the polymer emulsion is selected from the group consisting of acrylic polymers, acrylic copolymers, copolymers of styrene and butadiene, vinyl acetate polymers, polyvinyl alcohol, poly-ethylene vinyl acetate, polyethylene vinyl chloride, polyvinylidiene chloride and mixtures thereof.

9. The method of claim 8, wherein the acrylic polymer is selected from the group consisting of ethyl acrylate, methylmethacrylate, butylacrylate, 2-theylhexyl acrylate, methylacrylate, ethylmethacrylate, and mixtures thereof.

10. The method of claim 8, wherein the polymer emulsion is an acrylic emulsion or a styrenebutadiene emulsion.

11. The method of claim 1, wherein the pigment is selected from the group consisting of aqueous dispersions of coating grade clays, titanium dioxide, calcium carbonate, barium sulfate, talc, zinc sulfate, aluminum sulfate, calcium oxide reaction products, lithopone, zinc sulfide, and mixtures thereof.

12. The method of claim 11, wherein the pigment is talc.

13. The method of claim 1, wherein from about 5 g/m² to about 10 g/m² of aqueous coating is applied with a rod or a bar.

14. The method of claim 1, wherein more than one coating layer is applied to a surface of the paper or paperboard.

15. The method of claim 14, wherein each coating layer is formed from a different polymer emulsion.

16. The method of claim 1, wherein at least one coating layer is applied to each side of the paper or paperboard.

17. A coated paper or paperboard product comprising:
a baseboard layer coated on at least one side with a first coating layer formed from a first acrylic polymer emulsion; and
a second coating layer contacting the first coating layer, the second coating layer formed from a second acrylic polymer emulsion,
the coated paper or paperboard product having a water resistance of less than about 10 g/m² and a moisture vapor transfer rate of less than 120 g/m² after 24 hours at 25° C. and a relative humidity of 75%,
wherein the coated paper or paperboard product is heatseable.

18. The coated paperboard product of claim 17, wherein the first and second acrylic polymer emulsions are selected from the group consisting of ethyl acrylate, methylmethacrylate, butylacrylate, 2-theylhexyl acrylate, methylacrylate, ethylmethacrylate, and mixtures thereof.

19. The coated paperboard product of claim 17, wherein the first and/or second coating layer includes a pigment selected from the group consisting of grade clays, titanium dioxide, calcium carbonate, barium sulfate, talc, zinc sulfate, aluminum sulfate, calcium oxide reaction products, lithopone, zinc sulfide, and mixtures thereof.

20. The method of claim 19, wherein the pigment is talc.

21. A coated paper or paperboard product comprising:
a baseboard layer coated on at least one side with a first coating layer formed from a styrenebutadiene emulsion; and
a second coating layer contacting the first coating layer, the second coating layer formed from an acrylic polymer emulsion,
the coated paperboard product having a water resistance of less than about 7 g/m² and a moisture vapor transfer rate of less than 30 g/m² after 24 hours at 25° C. and a relative humidity of 75%,
wherein the coated paper or paperboard product is heat sealable.

22. The coated paperboard product of claim 21, wherein the acrylic polymer emulsion is selected from the group consisting of ethyl acrylate, methylmethacrylate, butylacrylate, 2-theylhexyl acrylate, methylacrylate, ethylmethacrylate, and mixtures thereof.

23. The coated paperboard product of claim 21, wherein the first and/or second coating layer includes a pigment selected from the group consisting of grade clays, titanium dioxide, calcium carbonate, barium sulfate, talc, zinc sulfate, aluminum sulfate, calcium oxide reaction products, lithopone, zinc sulfide, and mixtures thereof.

24. The method of claim 23, wherein the pigment is talc.
